(19) United States
(12) Patent Application Publication
(10) Pub. No.: US 2016/0176455 A1
(43) Pub. Date: Jun. 23, 2016

(54) Track-Type Machine Idler Yoke Assembly

(71) Applicant: Caterpillar Inc., Peoria, IL (US)

(72) Inventor: Joshua Nuechterlein, Washington, IL (US)

(73) Assignee: CATERPILLAR INC., Peoria, IL (US)

(21) Appl. No.: 14/577,718

(22) Filed: Dec. 19, 2014

(51) Int. Cl. B62D 55/15; B62D 55/32; B62D 55/30

(52) U.S. Cl. CPC B62D 55/15; B62D 55/30; B62D 55/32

(57) ABSTRACT

An idler yoke assembly for a track system of a track-type machine is disclosed. The assembly includes a yoke configured to support an idler wheel of the track system and is operatively coupled with a tensioning member of the track system. The yoke further includes a first arm having a first keyway and a wear strip secured to the first keyway. The wear strip is configured for sliding engagement with a key of the track system as the yoke moves relative to a track roller frame of the track system.

### FIELD OF THE DISCLOSURE

This disclosure generally relates to track-type machines and, more specifically, relates to idler yoke assemblies for track-type machines.

### BACKGROUND OF THE DISCLOSURE

Track-type machines, such as track-type tractors, excavators, bulldozers, track loaders and skid-steer loaders, are used in a variety of applications. Generally speaking, these machines have an operator station, a power source, an undercarriage and a pair of track systems laterally flanking the machine. Each track system includes a track roller frame positioned along a lengthwise-extending direction of the track-type machine and a drive sprocket that is rotatably driven by the power source. In one design, the drive sprocket is located at one end the track roller frame. In another design, known as a high drive system, the drive sprocket is positioned above and toward one end of the frame.

Each track system also includes one or more idler wheels. If the drive sprocket is located at one end of the track roller frame, the idler wheel is positioned at an opposite end of the frame. If the drive sprocket is positioned above and towards one end of the track roller frame, the track system includes idler wheels positioned at each end of the frame. Further, such track systems typically include one or more upper and/or lower rollers. These rollers are located along the lengthwise-extending axis of the track roller frame between the sprocket and the one or more idler wheels. Such track systems also include an endless track that circumscribes the drive sprocket, the one or more idler wheels, and the rollers. The endless track is rotatably engaged with the drive sprocket and transfers the energy of the power source to the ground to thereby provide locomotion to the track-type machine.

Maintaining proper tension on the endless track is important to the operation of track-type machines. Therefore, at least one of the one or more idler wheels may move relative to the track roller frame in a direction generally along the lengthwise-extending axis of the track roller frame. This movement is possible due to at least one of the one or more idler wheels being supported by a yoke that is engaged with the track roller frame by a key and keyway system. This key and keyway system, however, may be susceptible to wear, such as at the interface between the key and keyway.

One attempt to reduce the wear experienced between components is disclosed in U.S. Pat. No. 4,042,117 (the '117 patent). The '117 patent is directed to a wear plate for use in a connection assembly for coupling railway cars together. More specifically, when railway cars are coupled together and in motion, the cars move towards and away from each other, and the connection assembly is provided to take up and allow for such slack. The '117 patent does so by providing a shank that slides with a sill, with a coupler extending from the shank for connection to an adjacent railcar. The slack in such assembly is limited by a draft key that is positioned in a slot extending through the shank and sill. Given the weight of the coupler, when the shank slides within the sill, the shank is biased upwardly against the sill, thereby causing the draft key to frictionally engage an upper surface of the slot. Over time, this causes wear and deterioration of the sill. The '117 patent therefore provides a wear plate on the upper surface.

While arguably effective for its specific purpose, the '117 patent is related to railway cars and in no way to track-type machines. Moreover, a track-type machine and its associated track systems are subjected to external forces significantly different from rail cars. For example, while rail cars ride along a predefined railway with little deviation in horizontal angle, track-type machines are typically employed in earth-moving operations which subject them to terrain that is dynamic and more challenging. In addition, the loads experienced by a track-type tractor are more extreme and intermittent than the typically smooth course traversed by a railcar. The nature of the work performed by track-type tractors can also cause the track systems to be subjected to loads coming from practically every angle, thereby potentially causing wear on multiple surfaces of the key and keyway system.

The present disclosure is directed to overcoming one or more of the problems set forth above and/or other problems associated with the prior art.

### SUMMARY OF THE DISCLOSURE

In accordance with one aspect of the present disclosure, an idler yoke assembly for a track system of a track-type machine is disclosed. The idler yoke assembly includes a yoke configured to support an idler wheel of the track system and be operatively coupled with a tensioning member of the track system. The yoke further includes a first arm having a first keyway. A wear strip is secured to the first keyway with the wear strip being configured for sliding engagement with a key of the track system as the yoke moves relative to the track system.

In accordance with another aspect of the present disclosure, a track-system for a track type machine is disclosed. The track-system includes a track roller frame and a tensioning member operatively coupled with the track roller frame. The track-system further includes a yoke operatively coupled with the tensioning member. The yoke has a first arm, a second arm spaced apart from the first arm, with the first arm including a first keyway and the second arm including a second keyway. An idler wheel is rotatably disposed between the first arm and the second arm.

In accordance with another aspect of the present disclosure, a method of operating an idler yoke assembly of a track system is disclosed, wherein the idler yoke assembly includes a key and a yoke having a keyway. In a first step, a first wear strip is secured to a first surface of the keyway. Next, a second wear strip is secured to a second surface of the keyway. The key is then slid within the keyway with the key engaging the first and second wear strips.

These and other aspects and features of the present disclosure will be more readily understood when read in conjunction with the accompanying drawings.

### BRIEF DESCRIPTION OF THE DRAWINGS

FIG. 1 is a side elevation view of a track-type machine constructed in accordance with the present disclosure.

FIG. 2 is a side elevation view of an exemplary track system (without the endless track depicted) that may be used in conjunction with the track-type machine of FIG. 1.

FIG. 3 is a side elevation view of an alternative exemplary track system (also without the endless track depicted) that may be used in conjunction with the track-type machine of FIG. 1.

FIG. 4 is a side elevation view of an exemplary yoke assembly and idler wheel that may be used in conjunction with the track system of FIGS. 2 and 3.

FIG. 5 is a top view of the yoke assembly and idler wheel of FIG. 4.

FIG. 6 is an isometric view showing the yoke of FIG. 4.

FIG. 7 is a cross-sectional view, taken along line 7-7 in FIG. 5.

FIG. 8 is a cross-sectional view taken along line 8-8 of FIG. 5.

FIG. 9 is an isometric view showing a wear strip that may be used with the yoke assembly of FIG. 4.

FIG. 10 is a flowchart depicting an exemplary method of preparing and operating a yoke assembly of a track system of a track-type machine.

### DETAILED DESCRIPTION OF THE DISCLOSURE

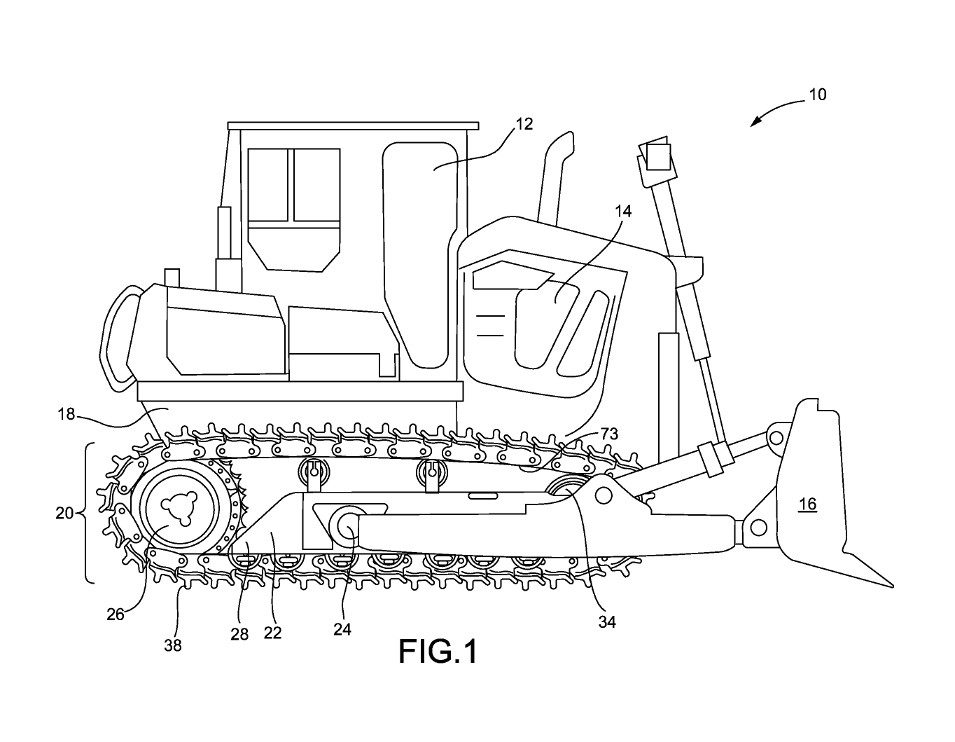

Referring now to the drawings, and with specific reference to FIG. 1, a track-type machine constructed in accordance with the present disclosure is generally referred to by reference numeral 10. The track-type machine 10 includes an operator station 12, a power source 14 for generating power, a work tool or implement 16, and an undercarriage 18 supporting the operator station 12 and the power source 14. The power source 14 may be provided in any number of different forms including, but not limited to, Otto and Diesel cycle internal combustion engines, electric motors, and the like. The track-type machine 10 further includes one or more track systems 20 (only one being shown in FIG. 1) laterally flanking the track-type machine 10. While only one such track system 20 is depicted in the side view of FIG. 1, it is to be understood that a mirror-image track system 20 may also be disposed on the other side of track-type machine 10. While the track-type machine 10 illustrated in FIG. 1 is a track loader, this disclosure is also relevant to other types of track-type machines 10, including, but not limited to, excavators, dozers, skid-steer loaders and the like.

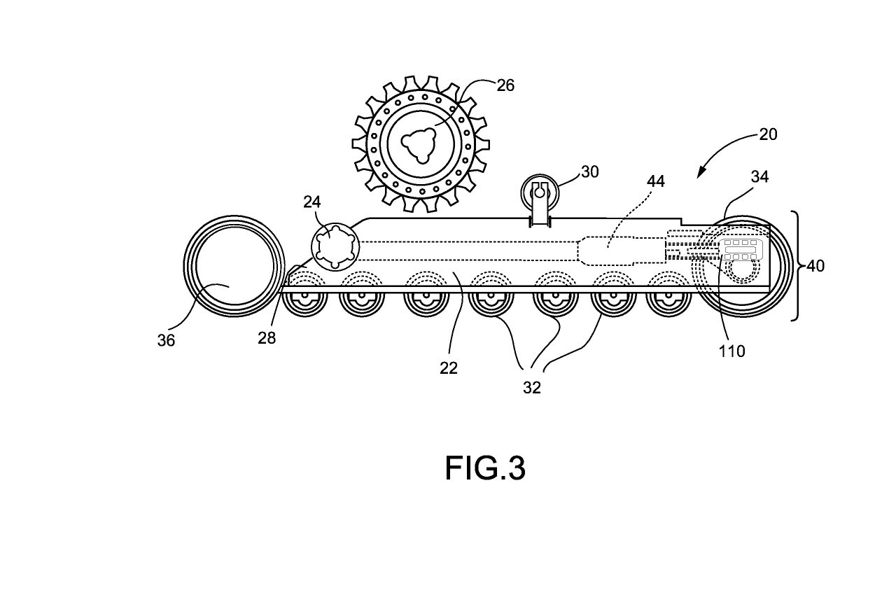

Referring to FIGS. 1-3, the track system 20 includes a track roller frame 22 positioned along a lengthwise-extending direction of the track-type machine 10 and is pivotably mounted to the undercarriage 18 at a pivot point 24. The track system 20 further includes a drive sprocket 26 that is rotatably driven by the power source 14. The drive sprocket 26 may be located at a first end 28 of the track roller frame 22. Alternatively, in a high-drive system, the drive sprocket 26 may be located above the track roller frame 22 and towards the first end 28 of the track system 20 as is depicted in FIG. 3.

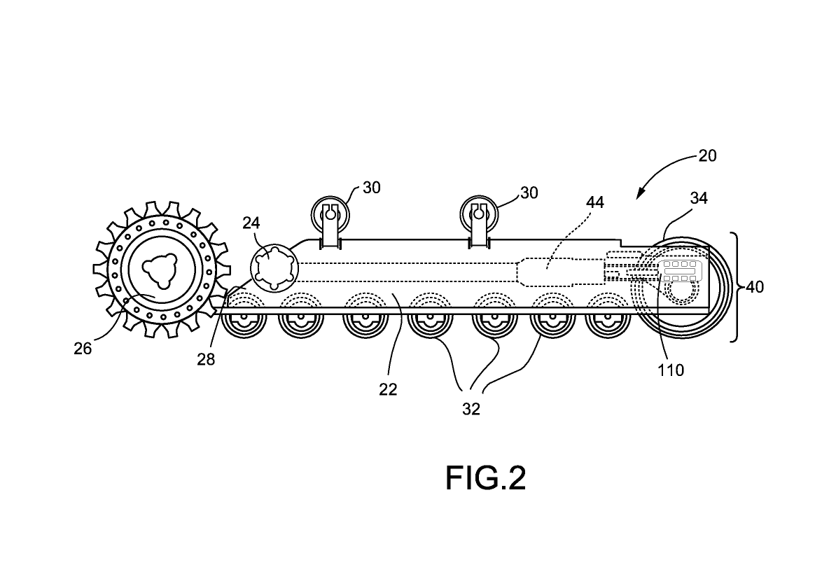

In addition, the track system 20 includes one or more upper rollers 30 operatively secured to and upwardly extending from the track roller frame 22. Opposite the one or more upper rollers 30, the track system 20 further includes one or more lower rollers 32 operatively secured to the track roller frame 22. Further, the track system 22 includes one or more idler wheels 34, 36. If the drive sprocket 26 is located at the first end 28 of the track roller frame 22 as depicted in FIG. 2, the track system includes a first idler wheel 34 located at an end of the track roller frame 22 opposite the first end 28. If the drive sprocket 26 is located above the track roller frame 22 towards the first end 28 of the track roller frame 22 as illustrated in FIG. 3, the track system 22 includes a first idler wheel 34 located at an end of the track roller frame opposite the first end 28, and may further include the second idler wheel 36 located at the first end 28.

Further, the track system 22 also includes an endless track 38. The endless track 38 circumscribes the drive sprocket 26, the upper rollers 30, the lower rollers 32 and the first idler wheel 34. Similarly, in a high drive system where the drive sprocket 26 is located above the track roller frame 22 towards the first end 28 of the track roller frame 22 as illustrated in FIG. 3, the endless track 38 may also circumscribe the second idler wheel 36. In either instance, the endless track 38 is rotatably engaged with the drive sprocket 26 and transfers the energy of the power source 14 to the ground. Finally, the track system 20 includes an idler yoke assembly 40. As depicted in FIGS. 2-3, the idler yoke assembly 40 is associated with the first idler wheel 34. While not shown, an idler yoke assembly 40 may also be associated with the second idler wheel 36.

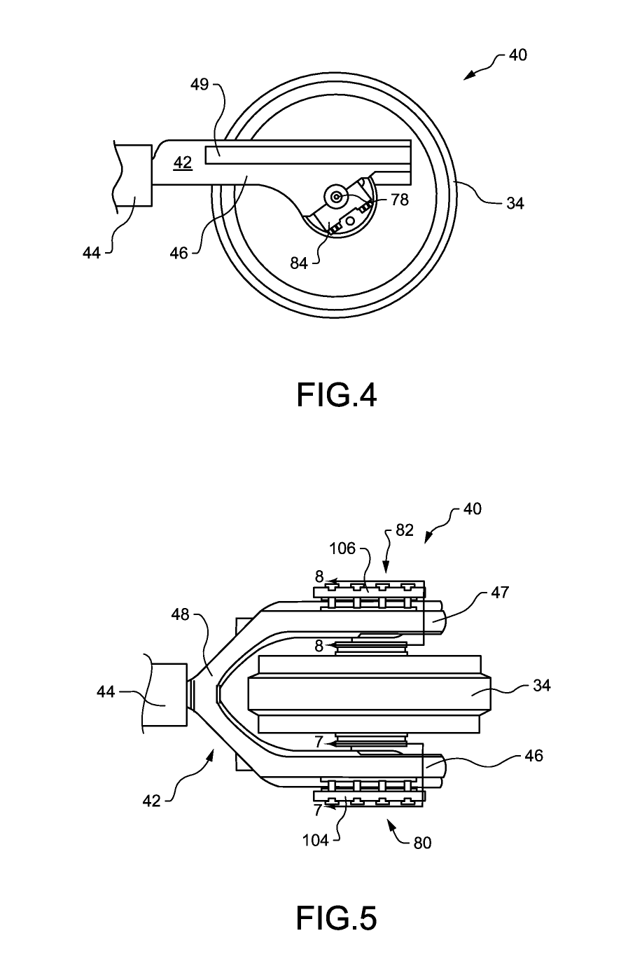

Turning now to FIGS. 4-5, an exemplary idler yoke assembly 40 is depicted. The idler yoke assembly 40 includes a yoke 42 configured to support the idler wheel 34 of the track system 20 and is operatively coupled to a tensioning member 44 of the track system 20. The tensioning member 44 is linearly actuable or otherwise movable so as to bias the yoke 42 and idler wheel 34 in a direction enabling the track 38 to remain at an appropriate tension. As shown best in FIG. 5, the yoke 42 may be bifurcated to include first and second arms 46, 47 which extend from an apex 48. In so doing, the yoke 42 is able to rotationally journal the idler wheel 34 from both sides for better and more reliable rotation.

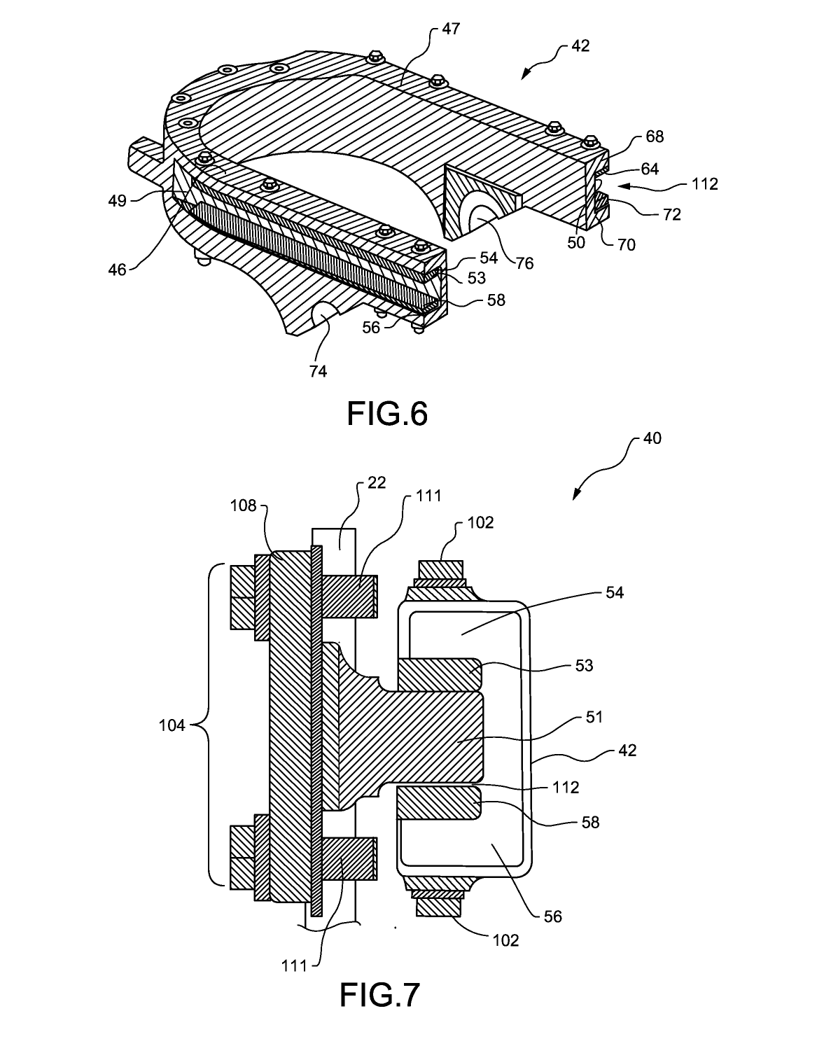

Referring now to FIGS. 4-8, and with specific reference to FIG. 6, the first arm 46 is shown to include a first keyway 49, while the second arm 47 is similarly configured to include a second keyway 50. As will be described in greater detail herein, the keyways 49 and 50 slidably engage first key 51 and second key 52 that are operatively associated with the track roller frame 22, respectively, when directed by tensioning member 44 to maintain tension in track 38. With prior art devices, such slidable and frictional engagement between the keys 51, 52 and keyways 49 and 50 may lead to deterioration of one or all of these components. Over time, this can cause decreased functionality or performance and ultimately require replacement or refurbishment at significant expense.

In light of this, the present disclosure significantly improves upon the prior art by, among other things, providing replaceable wear strips on the keyways 49 and 50. More specifically, a first wear strip 53 may be secured into the first keyway 49. The first wear strip 53 is configured for sliding engagement with the key 51 of the track system 20 as the yoke 42 moves relative to the track roller frame 22 of the track system 20, as shown best in FIG. 7. In so doing, the wear strip 53 is subjected to the resulting friction and wear, not the keyway 49.

In addition, more than one wear strip may be provided in each keyway. As opposed to rail and other applications subjected only to wear on an upper surface or the like, the keyways of a track-type tractor are subjected to frictional wear in many locations and from many directions. Accordingly, the first keyway 49 may further include a first upper ledge 54 and a first lower ledge 56, with the first wear strip 53 secured to either the first upper ledge 54 or the first lower ledge 56, and a second wear strip 58 secured to the other ledge. In the embodiment of FIG. 6, the first wear strip 53 is secured to the first upper ledge 54 and the second wear strip 58 is secured to the first lower ledge 56. Further, in this embodiment, the first wear strip 53 and second wear strip 58 are both configured for sliding engagement with the first key 51 of the track system 20 as the yoke 42 moves relative to the track roller frame 22 of the track system 20.

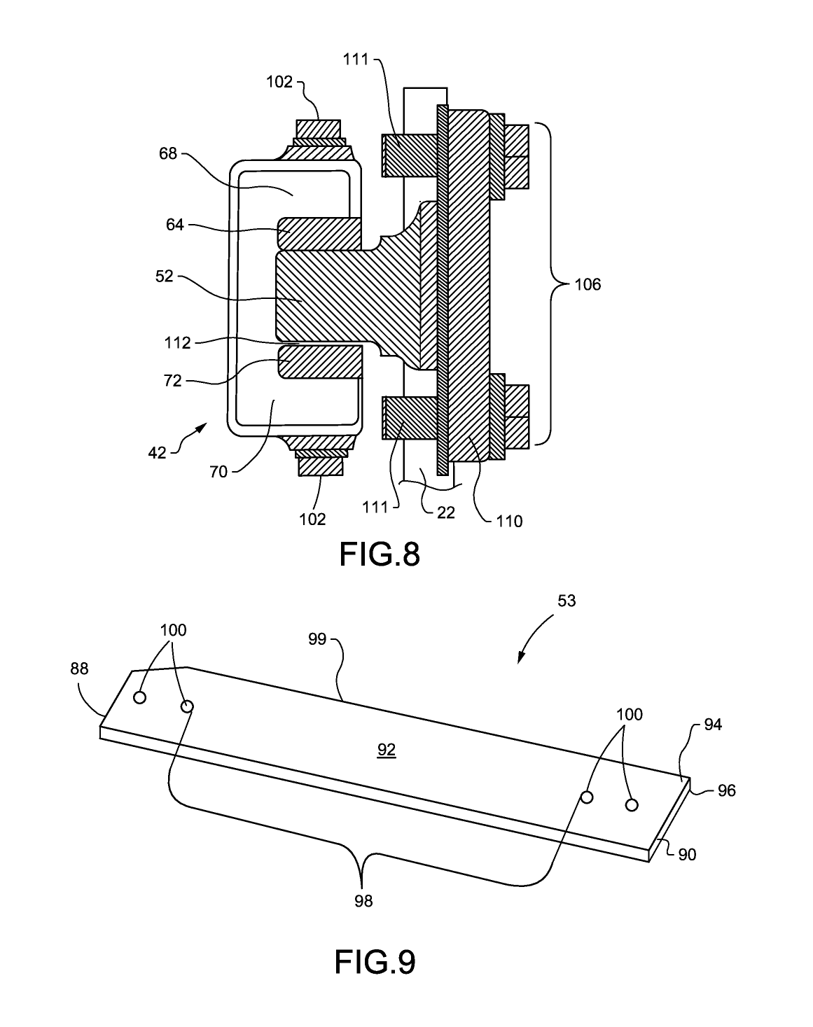

The second arm 47 and second keyway 50 may be similarly provided with wear strips. More specifically, a third wear strip 64 may be secured into the second keyway 50, as shown best in FIGS. 6 and 8. In this, and other embodiments, the third wear strip 64 is configured for sliding engagement with the second key 52 of the track system 20 as the yoke 42 moves relative to the track roller frame 22 of the track system 20. Additionally, the second keyway 50 may include a second upper ledge 68 and a second lower ledge 70, and the third wear strip 64 may be secured to the second upper ledge 68, with the third wear strip 64 being configured for sliding engagement with the second key 52 of the track system 20. Additionally, the idler yoke assembly 40 may include a fourth wear strip 72. In such an embodiment, the third wear strip 64 may be secured to the second upper ledge 68 and the fourth wear strip 72 may be secured to the second lower ledge 70, or vice versa. Both the third wear strip 64 and fourth wear strip 72 are configured for sliding engagement with the second key 52 of the track system 20 as the yoke 42 moves relative to the track roller frame 22 of the track system 20.

Referring now to FIG. 5, the first idler wheel 34 is shown to be rotatably journalled between the first arm 46 and second arm 47 of the yoke 42. Further, the first idler wheel 34 is engaged with an underside 73 of the endless track 38, as shown in FIG. 1. Additionally, as shown best in FIG. 6, the first arm 46 of the yoke 42 may include a first partial bore 74 and the second arm 47 may include a second partial bore 76. Such bores 74, 76 facilitate mounting of the first idler wheel 34 by a shaft 78 extending through the first idler wheel 34, as shown in FIG. 4. More specifically, the shaft 78 includes a first end 80 and a second end 82, as shown in FIG. 5. The first end 80 of the shaft 78 is mounted within the first partial bore 74 and the second end 82 of the shaft 78 is mounted within the second partial bore 76. The shaft 78 may be secured to the yoke 42 at the partial bores 74, 76 by one or more couplers 84.

Turning now to FIG. 9, an exemplary wear strip that is representative of the first, second, third, and fourth wear strips 53, 58, 64, 72 is depicted. For ease of illustration the wear strip of FIG. 9 is enumerated as first wear strip 53, but it is to be understood that such a wear strip could be used with equal efficacy as any of second, third and fourth wear strips 58, 64, and 72 as well. As illustrated, the wear strip 53 includes a first end 88, a second end 90 and a body 92 extending between the first end 88 and the second end 90. The length of the body 92 may be about less than or equal to the length of the first keyway 49 or the second keyway 50. The body 92 further includes a thickness that extends between a top-side 94 and a bottom-side 96.

With regard to choice of materials, the wear strip 53 may be made from any number of different materials including, but not limited to, materials which are the same or different from the material from which the yoke 42 is manufactured.

The wear strip 53 may be designed so that its lifespan coincides with a service life of the track system 20. If the body 92 lacks appropriate thickness, or the material chosen to make the wear strip 53 lacks suitable hardness, the strip 53 may be worn through by the time the track system 20 is serviced. Such a situation may lead to undesirable wear on the yoke 42. On the other hand, if the thickness of the body 92 is too great to begin with, the strip 53 may fail to wear a suitable amount by the time the track system 20 is to be serviced. In such a circumstance, the idler wheel 34 may become overly worn, thereby inhibiting machine performance. Correspondingly, the thickness of the wear strip 53 may be greater than or equal to about eight (8) millimeters and less than or equal to about sixteen (16) millimeters, although such dimensions are simply exemplary. In some embodiments, the thickness of the wear strip 53 may be greater than or equal to about ten (10) millimeters and less than or equal to about fourteen (14) millimeters. In these or other embodiments, the thickness of the wear strip 53 may be about, or equal to, twelve (12) millimeters. Other dimensions are certainly possible. As an appropriate hardness is also of import, in one exemplary embodiment, the hardness level of the material is less than or about equal to Rockwell C53. Other hardness levels are certainly possible.

The wear strip 53 may further include a wear zone 98 that extends along a mid-section 99 of the body 92. The wear zone 98 is the portion of the wear strip 53 is in contact with the first key 51 or the second key 52 as the yoke 42 moves relative to the track roller frame 22 of the track system 20.

The wear strip 53 may be secured to the first keyway 49 or the second keyway 50 by any number of different methods including, but not limited to, welding, brazing or the like. Alternatively, the wear strip 53 may be secured to the keyways 49, 50 by a chemical material, such as an adhesive. Another choice for securing the wear strip 53 to the keyways 49, 50 is through mechanical fastening. In such an embodiment, the wear strip 53 may include one or more threaded holes 100. Such threaded holes 100 may be located outside the wear zone 98 towards the first end 88 and second end 90 of the wear strip 53, or such holes 100 may be located inside the wear zone 98. Such threaded holes 100 may be through-holes or blind holes. Furthermore, threaded bolts 102 may be used to attach the wear strip 53 to its respective keyway 49, 50 as depicted in FIGS. 7-8. The bolts 102 may further include a locking patch, not shown, made of an elastomeric material located at one end of the threaded body of the bolt to prevent the bolt from backing-out of the threaded hole 100.

Referring now to FIGS. 7-8, the idler yoke assembly 40 may further include a first key assembly 104 and a second key assembly 106. The first key assembly 104 is associated with the first arm 46, while the second key assembly 106 is associated with the second arm 47. The first key assembly 104 includes a first flange 108 that is abutted against the track roller frame 22 of the track system 20 and the first key 51 extends inwardly from the first flange 108. The second key assembly 106 includes a second flange 110 that is abutted against the track roller frame 22 of the track system and the second key 52 extends inwardly from the second flange 110. The key assemblies 104, 106 may be secured to the track roller frame 22 by welding, brazing, adhesive, mechanical fasteners or the like, such as bolts 111.

In operation, the first key 51 and second key 52 of the key assemblies 104, 106 are supported by the track roller frame 22. Each key 51, 52 extends through the track roller frame 22 of the track system 20 and is received in a channel 112 between its respective wear strips 53, 58 and 64, 72 in its respective keyway 49, 50. The keys 51, 52 therefore slidably support the yoke 42 of the idler yoke assembly 40. The yoke 42 in turn rotatably supports the first idler wheel 34 by the partial bores 74, 76, the shaft 78 and the couplers 84. The underside 73 of the endless track 38 is engaged with and supported by the first idler wheel 34.

Under normal conditions, the tensioning member 44 biases the first idler wheel 34 towards the end of the track roller frame 22 opposite the first end 28. In the event the endless track 38 collides with an object, or otherwise encounters inconsistent resistance, the yoke 42 moves relative to the track roller frame 22 towards the first end 28 along the interface between the keys 51, 52 and the wear strips 53, 58, 64, 72. Then, after the collision subsides, or the obstruction is otherwise overcome, the tensioning member 44 moves the yoke 42 away from the first end 28 along interface between the keys 51, 52 and the wear strips 53, 58, 64, 72.

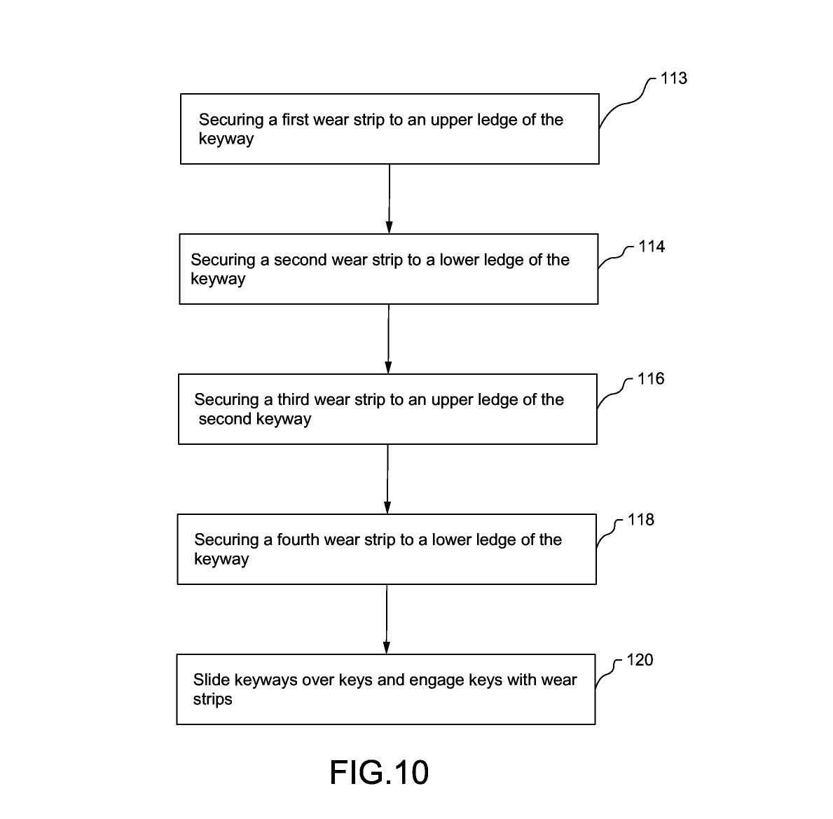

Referring next to FIG. 10, steps of a method for preparing and operating an idler yoke assembly 40 of a track system 20 are illustrated. At a step 113, the first wear strip 53 is secured to the first upper ledge 54 of the first keyway 49. At a step 114, the second wear strip 58 is secured to the first lower ledge 56 of the first keyway 49. At a step 116, the third wear strip 64 may be secured to the second upper ledge 68 of the second keyway 50, and at a step 118 the fourth wear strip 72 may be secured to the second lower ledge 70 of the second keyway 50. Of course, such steps of the foregoing method may be practiced in any particular order. The idler yoke assembly 40 is then operated by sliding the keyways 49, 50 over the keys 51, 52, respectively, with the keys 51, 52 frictionally engaging the wear strips 53, 58, 64, and 72, not the keyways 49 and 50, as shown in a step 120.

### INDUSTRIAL APPLICABILITY

In operation, an idler yoke assembly having wear strips can find use in many industrial applications, such as in a track system of a track-type machine. More specifically, the idler yoke assembly with wear strips finds use in the track systems of track-type machines utilizing a key and keyway system to support the movement of a yoke relative to a track roller frame.

Generally, the track systems of track-type machines include the track roller frame and a sprocket located at one end of the track roller frame. Each system also includes one or more upper or lower rollers located along the track roller frame and an idler wheel located at an end of the track roller frame opposite the sprocket. The idler wheel is supported by an idler yoke assembly. The idler yoke assembly includes a yoke that is operatively coupled to a tensioning member of the track system. The yoke further includes a first arm and a second arm spaced apart from the first arm. The first and second arms each include keyways that are slidably engaged with a key of the track system.

During use, the track system may collide with an object, or otherwise encounter inconsistent resistance. In response, the yoke moves relative to the track roller frame along the surface between the keys and the keyways. Then, after the collision ends or the resistance is overcome, the tensioning member moves the yoke relative to the track roller frame towards a normal position along the surface between the keys and keyways. As repeated movement of the keyways relative to the keys deteriorates the surface of the keyways associated with the prior art, the present disclosure sets forth apparatus and methods which greatly abate such deterioration.

More specifically, to better sustain the life of the yoke, the present disclosure secures wear strips to one or more surfaces of the yoke keyways. For example, the wear strips may be secured to the upper ledges and lower ledges of the yoke keyways. Since the keys of the track system are received in the channels between the wear strips, when the track system collides with an object or otherwise encounters inconsistent resistance, the yoke moves relative to the track system with the keys frictionally engaging the wear strips as opposed to the keyways themselves. After repeated movement of the keyways relative to the keys, the wear strips may be removed and replaced, rather than requiring the entire yoke to be replaced, refurbished or remanufactured as is the case with the prior art. In so doing, considerable expense is avoided, and the serviceable life of the yoke assembly is enhanced.

The above description is meant to be representative only, and thus modifications may be made to the embodiments described herein without departing from the scope of the disclosure. Thus, these modifications fall within the scope of present disclosure and are intended to fall within the appended claims.

What is claimed is:

1. An idler yoke assembly for a track system of a track-type machine, comprising:
a yoke configured to support an idler wheel of the track system, the yoke operatively coupled with a tensioning member of the track system, the yoke having a first arm having a first keyway; and
a wear strip secured to the first keyway, the wear strip configured for sliding engagement with a key of the track system as the yoke moves relative to a track roller frame of the track system.

2. The idler yoke assembly for a track system according to claim 1, wherein the first keyway further includes a first upper ledge and a first lower ledge, wherein the wear strip is a first wear strip and the first wear strip is secured to the first upper ledge, wherein the key is a first key and the first wear strip is configured for sliding engagement with the first key as the yoke moves relative to the track roller frame of the track system.

3. The idler yoke assembly for a track system according to claim 1, wherein the first keyway further includes a first upper ledge and a first lower ledge, wherein the wear strip is a first wear strip and the first wear strip is secured to the first upper ledge, wherein the yoke assembly further includes a second wear strip and the second wear strip is secured to the first lower ledge, and wherein the key is a first key and the first wear strip and the second wear strip are configured for sliding engagement with the first key as the yoke moves relative to the track roller frame of the track system.

4. The idler yoke assembly for a track system according to claim 1, wherein the first keyway further includes a first upper ledge and a first lower ledge, wherein the wear strip is a first wear strip and the first wear strip is secured to the first upper ledge, wherein the yoke assembly further includes a second wear strip and the second wear strip is secured to the first lower ledge, wherein the key is a first key and the first wear strip and the second wear strip are configured for sliding engagement with the first key as the yoke moves relative to the track roller frame of the system, wherein the yoke further includes a second arm spaced apart from the first arm and the second arm includes a second keyway, wherein the second keyway further includes a second upper ledge and a second lower ledge, wherein the yoke assembly further includes a third wear strip secured to the second upper ledge, wherein the yoke assembly further includes a second key and wherein the third wear strip is configured for sliding engagement with the second key as the yoke moves relative to the track roller frame of the track system.

5. The idler yoke assembly for a track system according to claim 1, wherein the first keyway further includes a first upper ledge and a first lower ledge, wherein the wear strip is a first wear strip and the first wear strip is secured to the first upper ledge, wherein the yoke assembly further includes a second wear strip and the second wear strip is secured to the first lower ledge, wherein the key is a first key and the first wear strip and the second wear strip are configured for sliding engagement with the first key as the yoke moves relative to the track roller frame of the system, wherein the yoke further includes a second arm spaced apart from the first arm and the second arm includes a second keyway, wherein the second keyway further includes a second upper ledge and a second lower ledge, wherein the yoke assembly further includes a fourth wear strip secured to the second lower ledge, wherein the yoke assembly further includes a second key and wherein the third wear strip and the fourth wear strip are configured for sliding engagement with the second key as the yoke moves relative to the track roller frame of the track system.

6. The idler yoke assembly for a track system according to claim 4, further including an idler wheel rotatably disposed between the first arm and the second arm.

7. The idler yoke assembly for a track system according to claim 6, wherein the first arm further includes a first partial bore, the second arm further includes a second partial bore, a shaft extends through the idler wheel, the shaft has a first side and a second side, the first side of the shaft is operatively coupled with the first partial bore and the second side of the shaft is operatively coupled with the second partial bore.

8. The idler yoke assembly for a track system according to claim 5, further including an idler wheel rotatably disposed between the first arm and the second arm.

9. The idler yoke assembly for a track system according to claim 8, wherein the first arm further includes a first partial bore, the second arm further includes a second partial bore, a shaft extends through the idler wheel, the shaft has a first side and a second side, the first side of the shaft is operatively coupled with the first partial bore and the second side of the shaft is operatively coupled with the second partial bore.

10. A track system for a track-type machine, comprising:
a track roller frame;
a tensioning member operatively coupled with the track roller frame;
a yoke operatively coupled with the tensioning member, the yoke having a first arm and a second arm spaced apart from the first arm, the first arm having a first keyway and the second arm having a second keyway; and
an idler wheel rotatably disposed between the first arm and the second arm.

11. The track-system for a track type machine according to claim 10, wherein the first keyway further includes a first upper ledge and a first lower ledge, wherein a first wear strip is secured to the first upper ledge and a second wear strip is secured to the first lower ledge, and the track system further includes a first key and the first wear strip and second wear strip are slidably engaged with the first key as the yoke moves in relation to the track roller frame.

12. The track system for a track-type machine according to claim 11, wherein the second keyway includes a second upper ledge and a second lower ledge, wherein a third wear strip is secured to the second upper ledge and a fourth wear strip is secured to the second lower ledge, and the track system further includes a second key and the third wear strip and fourth wear strip are slidably engaged with the second key as the yoke moves with in relation to the track roller frame.

13. The track-system for a track type machine according to claim 10, wherein the first arm further includes a first partial bore and the second arm further includes a second partial bore, the first and second partial bores configured for receiving a shaft that extends through and supports the idler wheel.

14. The track-system for a track type machine according to claim 12, further including a drive sprocket located towards an end of the track roller frame opposite the yoke.

15. The track-system for a track type machine according to claim 14, further including one or more upper or lower rollers positioned along a lengthwise-extending axis of the track roller frame, and further positioned between the sprocket and the idler wheel.

16. The track-system for a track type machine according to claim 15, further including an endless track, the endless track defining a path that circumscribes the drive sprocket, the one or more upper or lower rollers and the idler wheel.

17. A method of operating an idler yoke assembly of a track system is disclosed, wherein the idler yoke assembly includes a key and a yoke having a keyway, the method comprising:
securing a first wear strip to a first surface of the keyway;
securing a second wear strip to a second surface of the keyway; and
sliding the keyway over the key with the key engaging the first and second wear strips.

18. The method according to claim 17, wherein the keyway is a first keyway, the yoke further comprises a second keyway and the method further includes the steps of:
securing a third wear strip into an upper ledge of the second keyway; and
securing a fourth wear strip into a lower ledge of the second keyway.

19. The method according to claim 18, wherein the yoke comprises a first arm and a second arm spaced apart from the first arm, and the yoke assembly further includes an idler wheel rotatably disposed between the first and second arms.

20. The method according to claim 19, wherein the first and second wear strips are configured for sliding engagement with a first key of the track system, and the third and fourth wear strips are configured for sliding engagement with a second key of the track system.
